(19) United States
(12) Patent Application Publication
(10) Pub. No.: US 2024/0246522 A1
(43) Pub. Date: Jul. 25, 2024

(54) TRANSMISSION ASSEMBLY WITH A PLURALITY OF REDUCTION RATIOS, AND METHOD FOR OPERATING A TRANSMISSION ASSEMBLY

(71) Applicant: Continental Automotive Technologies GmbH, Hannover (DE)

(72) Inventors: Peter Stauder, Mainz (DE); Kristijan Tarandek, Neu-Isenburg (DE); Marco Besier, Bad Schwalbach (DE); Jürgen Böhm, Oberneisen (DE)

(73) Assignee: Continental Automotive Technologies GmbH, Hannover (DE)

(21) Appl. No.: 18/422,436

(22) Filed: Jan. 25, 2024

(30) Foreign Application Priority Data
Jan. 25, 2023 (DE) 10 2023 200 573.5

(51) Int. Cl. B60T 13/74; F16D 65/18; F16D 121/24; F16D 125/50; F16D 127/00

(52) U.S. Cl. CPC B60T 13/746; F16D 65/18; F16D 2121/24; F16D 2125/50; F16D 2127/00

(57) ABSTRACT

A transmission assembly has a plurality of reduction ratios. For this purpose, the transmission assembly can comprise a planetary transmission in which the annulus can rotate freely in a first direction of rotation and in which the annulus is held fixed against rotation in a second direction of rotation. A method of operating a transmission assembly is also disclosed.

### TECHNICAL FIELD

The present embodiments relate in general to a transmission assembly having a plurality of reduction ratios and to a method for operating a transmission assembly.

### BACKGROUND

In modern motor vehicles, increasing use is being made of electromechanical service brakes as opposed to conventional, hydraulically actuated, service brakes. Therefore, there is no longer a need for a complex hydraulic system, and an electromechanical service brake also takes up significantly less space.

Electromechanical service brakes of this kind typically have an electronic drive unit, which interacts with a transmission. Arranged on the output side of the transmission is a brake unit, which comprises a friction lining that acts on a brake disk.

A certain clearance must be provided between the friction lining and the brake disk to ensure that there is no rubbing on the brake during free, unbraked driving, something that can lead to the brake running hot. This minimum clearance is also referred to as a release clearance. This release clearance should be dimensioned in such a way that even slight wobbling of the brake disk cannot lead to rubbing during free driving, which could lead in turn to unequal wear on the brake disk. This may lead to changes in the braking torque. Moreover, consideration must also be given to potential heating of the brake unit, which can lead to expansion, e.g. of the brake disk.

The release clearance should therefore be configured in such a way that the possible operating conditions for the brake unit are covered. With a view also to the greatest possible reduction in the residual braking torque by the brake unit, the release clearance is therefore always designed to be relatively large and can quite easily be 0.5 mm or even more when the brake is cold.

In addition, there is the fact that both the friction or brake lining and the brake disk may wear by different amounts during the operation of the motor vehicle, and this may even increase the distance before contact.

The electronic drive unit often comprises at least one permanently excited DC motor, which has a high power density, wherein the mechanical connection to the friction brake is established by means of the transmission. In addition to factors such as efficiency, installation space requirement and stiffness, it is above all the transmission characteristic which determines the suitability of the transmission.

The transmission may have a linear transmission ratio or constant transmission ratio an increasingly long distance, predetermined by the release clearance, must be traversed before the desired physical effect, in particular the buildup of the desired clamping force for pressing the friction lining onto the brake disk, comes into action. A longer brake application distance has an effect on the force buildup and force modulation, i.e. the desired braking effect occurs only after a time delay, for example.

### SUMMARY

Therefore, transmissions with a nonlinear transmission ratio recommend themselves. In the case of a nonlinear component, the transmission ratio can be increased in the region of the release clearance, and thus a more rapid response time and a somewhat lower required input power with a lower torque can be achieved. Since a continuous change in the transmission ratio is used in the case of the known nonlinear rotation-translation converters, the possible travel is limited, however. Furthermore, the initial position from which the nonlinear transmission ratio takes effect must be known. Moreover, an additional means of adjustment for wear has to be provided to ensure that the working range does not change over the service time.

Accordingly, an electromechanical braking device which does not have or at least mitigates the abovementioned is desirable.

The aim is therefore an electromechanical wheel brake or a transmission assembly suitable for such a brake which allows the release clearance to be traversed quickly. In this case, dependence on the initial position from which the change in transmission ratio takes effect should be as low as possible.

At the same time, however, it should also be ensured that a sufficiently high brake application force can be made available quickly and reliably upon contact between the friction linings and the brake disk.

In addition, for reasons of installation space and cost, there should be no need for a second rotation-translation converter.

This object may be achieved by a transmission assembly having at least a first and a second reduction ratio, for example for a wheel brake for a motor vehicle, and by a method for operating a wheel brake for a motor vehicle.

In a first aspect, a transmission assembly having at least a first and a second reduction ratio, for example for an electromechanical wheel brake for a motor vehicle, comprising a planetary transmission having a sun wheel, which is connected for conjoint rotation to a drive shaft. A number of planet wheels are rotatably mounted on a planet carrier, and an annulus surrounding the planet wheels, wherein the planet carrier is connected for conjoint rotation to an output shaft. The planet wheels are supported by means of the planet carrier in such a way that they can roll both on the sun wheel and on the annulus. The annulus is designed as a freewheel or comprises a freewheel, and therefore the annulus can rotate freely in a first direction of rotation and is held fixed against rotation in a second, opposite direction of rotation during the operation of the transmission assembly. A clutch is provided between the drive shaft and the planet carrier.

A motor vehicle may refer to a vehicle that has axles, wherein at least one of these axles comprises steerably guided wheels and, furthermore, the driving of the wheels on at least one axle can be adapted in a wheel-specific manner.

In this case, the brake may be designed as an electromechanical wheel brake, wherein for example all the wheel brakes of the motor vehicle can be designed as electromechanical or electrically controllable wheel brakes.

In this case, the electromechanical wheel brake may be designed as a service brake. However, it is also possible to use the transmission assembly in or with a parking brake.

In this case, the electromechanical wheel brakes can be embodied as electromechanical disk brakes, in which a brake application force can be produced by means of an electric motor, an auxiliary transmission and/or a rotation-translation mechanism. In this context, the brake application force refers to the force with which the brake linings are pressed against the brake disk. In operation, a corresponding braking torque is thereby produced at the wheel under consideration. Depending on the embodiment and control concept, the control system can be selected in such a way that either a predetermined, defined clamping force or a predetermined, defined braking torque is set in accordance with the deceleration demand requested.

The electromechanical wheel brakes can also be designed as an electromechanical drum brake, in which the motor/transmission unit actuates an expansion module, which presses the brake linings against the brake drum with an expansion force determined on the basis of the desired deceleration requested and thus produces a corresponding braking torque. Depending on the embodiment and control concept, the control system can be designed in such a way that a defined expansion force or a defined braking torque is set in accordance with the deceleration demand requested.

For simplification and better comprehension, the terms brake lining and brake disk are used below in connection with a disk brake for example a partial-area disk brake, but it will be apparent to a person skilled in the art that the embodiments of the transmission assembly which are described can be used not only for electromechanical disk brakes of this kind but also in or with an electromechanical drum brake. However, the transmission assembly can also be used on or for a full-area disk or multi-disk brake.

A transmission assembly may be provided which is designed at least with a first and a second reduction ratio.

According to an embodiment, the transmission assembly comprises a planetary transmission having a sun wheel, which is connected for conjoint rotation to a drive shaft and can be driven directly or indirectly by an electric motor or an electronic drive unit. Planetary transmissions are assumed to be fundamentally known to those skilled in the art and will therefore only be briefly outlined.

A planetary transmission typically comprises a number of planet wheels, which are mounted rotatably on a spider or a planet carrier. The planet carrier is connected for conjoint rotation to the output shaft.

The planet wheels can roll on the sun wheel, for which purpose corresponding gearwheels can be provided. Furthermore, the planet wheels can likewise roll on a surrounding annulus.

During the operation of the transmission assembly, for example in combination with an actuator for an electromechanical wheel brake for a motor vehicle, a relatively small torque has to be applied initially to traverse the release clearance. This then rises when the brake linings come into contact with the brake disk and, for example, are pressed against the brake disk in order to produce a braking torque.

For this purpose, the output shaft can, for example, comprise a ball screw drive, which enables the rotary motion of the output shaft to be converted into a translational motion. This translational motion, in turn, can be used to move a brake lining in the direction of the brake disk.

The rise in the torque upon contact between the brake lining and the brake disk is used in order to shift the transmission assembly from the at least first to the second reduction ratio.

Here, the first reduction ratio forms as it were a rapid motion ratio in order to quickly traverse the release clearance as the brake lining is advanced during operation. The torque which must be applied during this process is relatively low and can, for example, be less than 5 Nm or even less than 1 Nm. “Low” can mean that it is below the torque which occurs during active braking, that is to say when the brake lining is pressed against the brake disk. In an embodiment, the magnitude of this low torque can be, for example, 10% or 5% or less of the torque which is required during an active braking process.

Accordingly, the first reduction ratio is used at lower torques or in a first, low torque range, in which essentially the release clearance is to be traversed and active braking is not yet taking place, i.e. the brake linings are still essentially out of contact with the brake disk

For this purpose, the required torque is transmitted directly from the drive shaft to the output shaft via the clutch, which is provided between the drive shaft and the planet carrier. This clutch ensures that the drive torque is transmitted as it were directly to the planet carrier and thus to the output shaft connected to the latter for conjoint rotation. This corresponds to the first reduction ratio, according to which the torque can be transmitted from the drive shaft to the output shaft via the clutch during the operation of the transmission assembly.

Up to a predetermined torque, the planet carrier, the sun wheel and the annulus thus rotate at the same speed and in the same direction of rotation, and the transmission ratio is accordingly 1. The predetermined torque is specified by a torque limit of the clutch. In other words, the torque limit of the clutch is chosen in such a way that it corresponds approximately to the torque at which the advance of the brake lining makes a transition to pressing of the brake lining against the brake disk. The clutch is thus designed in such a way that, up to the predetermined torque, it can transmit the drive torque on its own.

The freewheel of the annulus may be oriented in such a way that, during a rotation in the brake application direction, a rotation of the annulus can be brought about by the coupling of the sun wheel to the spider. Accordingly, the annulus can freely co-rotate.

When, as the brake is applied further, the drive torque then becomes higher than the torque that can be transmitted via the clutch, the drive torque can no longer be transmitted via the clutch since the torque is limited. This has the effect that the planet wheels are driven by the sun wheel. Without locking, this would lead to further rotation of the annulus in the opposite direction.

In a way, therefore, a freewheel is provided which prevents this reverse rotation of the annulus. In other words, by virtue of the freewheel, the annulus remains held fixed against rotation when the torque limit is exceeded, and the planetary transmission can operate with its second reduction ratio.

The second reduction ratio of the planetary transmission is thus used for the second torque range, in which a required torque for active braking must at least be made available in order to apply the required brake application force during the operation of the wheel brake. Here, this torque is typically higher and is above the first torque range and thus above the torque limit.

Holding the annulus fixed against rotation in the direction of reverse rotation has the effect that the torque of the drive shaft is transmitted to the planet wheels via the sun wheel and no longer via the clutch. Since the planet wheels are also in effective interaction with the annulus, which is stationary in this direction, and roll on the latter, this leads to rotation of the planet carrier and thus of the output shaft in accordance with the second reduction ratio.

Thus, an electromechanical wheel brake or a transmission assembly is provided which allows the release clearance to be traversed quickly and thus allows an improved response.

The transmission assembly operates freely from the initial position and makes it possible to switch between two reduction ratios in a purely mechanical way on the basis of the magnitude of the torque during the operation of the wheel brake.

In principle, it is also possible and conceivable to provide or integrate a sensor which records the current position of the drive shaft. These sensor data can then be used for shifting the transmission assembly, for example. By means of the sensor data, it is also possible, for example, to check whether the torque limit is still acting correctly or, for example, must be corrected owing to wear or changes in other influencing variables. It is likewise possible to determine the exact changeover time or angle which is used to calculate the piston position and the back-calculation of the acting clamping force from the motor torque.

The transmission assembly ensures that, when the brake linings make contact with the brake disk, a sufficiently high brake application force can be made available quickly and reliably, thus enabling active braking to take place after the release clearance has been traversed.

In this case, the transmission assembly requires only slight modifications to existing transmission assemblies and, as a result, can be integrated easily and cheaply into existing braking devices.

According to one embodiment, the planet carrier can have an axially projecting neck, which can enclose or surround at least a section of the drive shaft. The clutch can be arranged between the inner surface of the neck and the outer lateral surface of the drive shaft.

Another embodiment envisages arranging the clutch between the end face of the drive shaft and an inner wall of the planet carrier, allowing simple assembly.

The clutch serves for direct transmission of the drive torque to the planet carrier. In this way, a first reduction ratio of about 1:1 can be achieved in the direct drive mode of the transmission assembly.

As already explained, the clutch is designed with a torque limit. Here, the clutch is designed as a physically solid element and thus is not a viscous medium or fluid, i.e. the clutch is in a solid state of aggregation at a temperature of 20° C. Operation and assembly are thereby made easier.

In the case of a drive torque above the torque limit, the clutch can no longer transmit the torque, and the second reduction ratio comes into use. In the second torque range, a second reduction ratio of, for example, 1:5 to 1:8 can then be achieved.

The clutch can be designed as an “overload clutch”. This may mean that, when a predetermined torque is reached, the output can be separated from the input or acts to only a slight extent. Therefore, loss off driving energy is minimized due to the clutch in the second torque range, in which active braking takes place.

According to another embodiment, the clutch can also comprise a friction clutch, for example. The friction clutch can be designed in such a way, for example, that it applies a predetermined static friction to the drive shaft when it is firmly connected to the planet carrier or to the planet carrier when it is firmly connected to the drive shaft.

In a development of this embodiment, provision is made to combine the clutch with another freewheel in such a way that the clutch is in engagement only during the advance of the brake, and not during release. Therefore, no additional torque has to be produced during release. The clamping force of the brake can therefore be automatically released freely if the electronics fail.

According to an embodiment, an axial bearing is furthermore provided, via which an axial force that occurs during operation and may act on the output shaft can be absorbed and transmitted to the housing. For this purpose, the output shaft can comprise a radial projection, for example. The axial bearing can comprise a rolling bearing or a ball bearing, for example, although other embodiments are also conceivable and possible.

An aspect can be regarded as the fact that the annulus is designed as a freewheel or comprises a freewheel. By this means, it is possible to ensure that the annulus can rotate freely in a first direction of rotation during the operation of the transmission assembly. Here, the first direction of rotation may correspond to the direction of rotation of the drive shaft during brake application. In a second, opposite direction of rotation or in the event of a reversal of the direction of rotation, on the other hand, the annulus is held fixed against rotation, and therefore rotation of the annulus is locked.

According to an embodiment, the annulus can in this case comprise a freewheel, that is to say, for example, can be connected to the housing via a corresponding freewheel element. The freewheel element can be designed as a pawl-type freewheel, for example. A pawl-type freewheel allows rotation in a first direction of rotation and locks in the reverse direction of rotation by positive engagement of a pawl, which can engage in corresponding recesses.

The use of wedging elements or wedging rollers in or with the freewheel element is also possible. In this case, wedging rollers or elements can be pressed against another component in the locking direction by springs, thus bringing about wedging and locking by virtue of radial forces that arise.

In a further aspect includes an electromechanical wheel brake comprising a transmission assembly as described above. The electromechanical wheel brake can be used as a service brake. Use as a parking brake is also possible.

In yet another further aspect, also includes a method for operating an electromechanical wheel brake of a motor vehicle, comprising an electric motor and a transmission assembly as described above.

### DETAILED DESCRIPTION

Further details will become apparent from the description of the illustrated exemplary embodiments and the attached claims.

In the drawings:

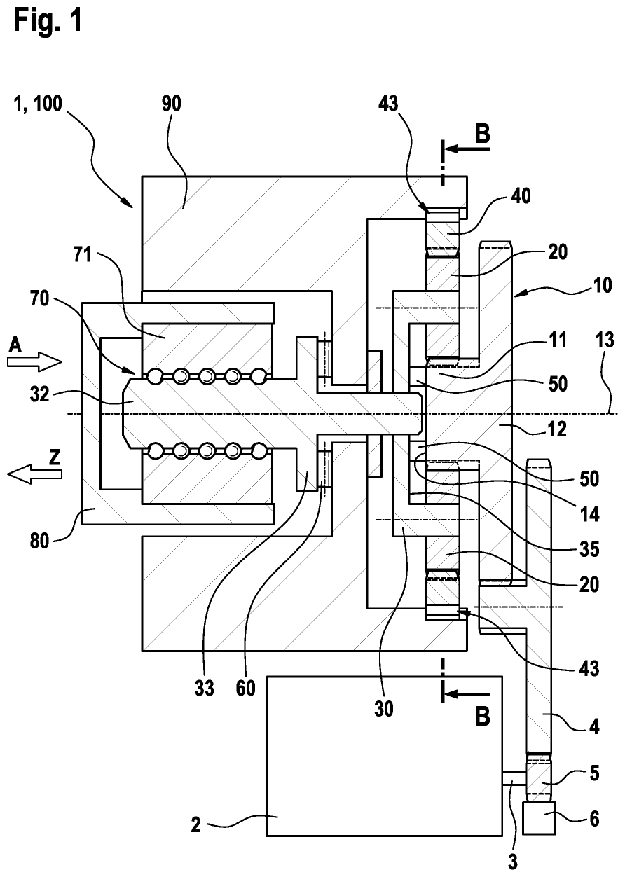

FIG. 1 shows a schematic view of a transmission assembly in section,

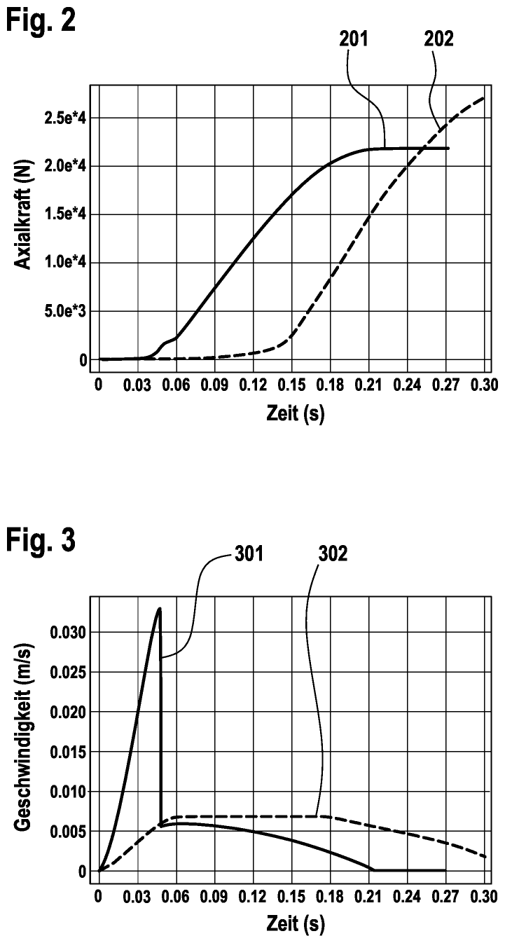

FIG. 2 shows, in a diagram, the characteristic of the axial force as a function of time during a braking process of a transmission assembly in comparison with a transmission assembly from the prior art,

FIG. 3 shows, in a diagram, the characteristic of the brake piston speed as a function of time during a braking process of a transmission assembly in comparison with a transmission assembly from the prior art,

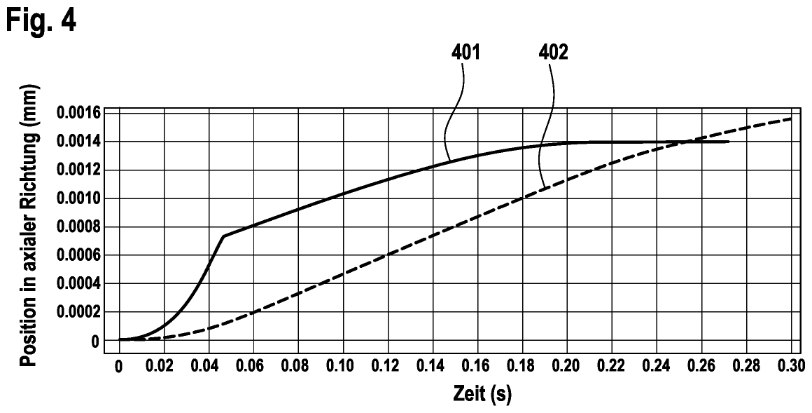

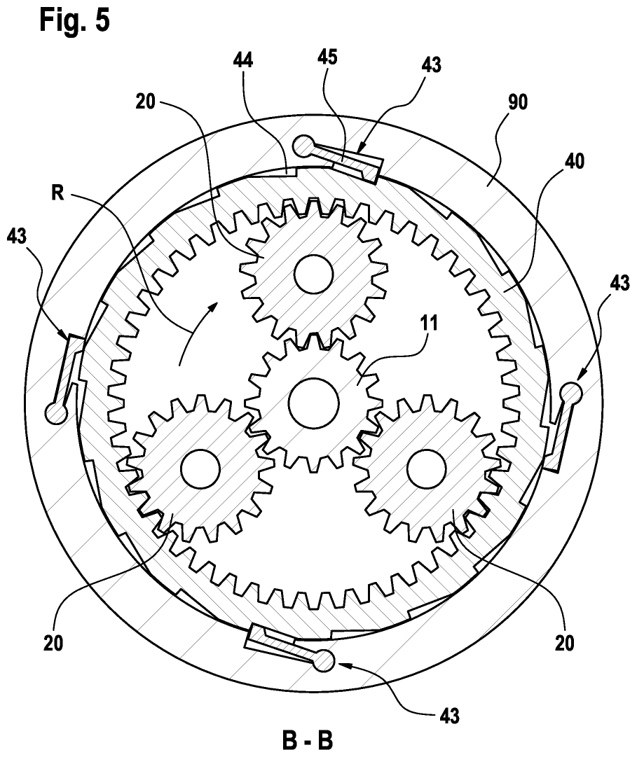

FIG. 4 shows, in a diagram, the change in the position of a braking element as a function of time during a braking process of a transmission assembly in comparison with a transmission assembly from the prior art, and

FIG. 5 shows a schematic sectional view of the transmission assembly from FIG. 1.

### DETAILED DESCRIPTION

In the following detailed description of embodiments, for the sake of clarity, the same reference signs designate substantially identical parts in or on these embodiments. However, for better clarification, the embodiments illustrated in the figures may not always drawn to scale.

For reasons of clarity, only those elements of a wheel brake 100 which are relevant for the embodiment of the approach are illustrated here.

FIG. 1 shows a view of a transmission assembly 1 as part of an electromechanical wheel brake 100 in a longitudinal section with some elements, although there is no claim to completeness.

The transmission assembly 1 is designed with at least a first and a second reduction ratio and comprises a planetary transmission 10 having a sun wheel 11, which is connected for conjoint rotation to a drive shaft 12, a number of planet wheels 20, which are rotatably mounted on a planet carrier 30, and an annulus 40 surrounding the planet wheels 20, wherein the planet carrier 30 is connected for conjoint rotation to an output shaft 32, wherein the planet wheels 20 are supported by means of the planet carrier 30 in such a way that they can roll both on the sun wheel 11 and on the annulus 18, wherein the annulus 40 is designed as a freewheel 43 or comprises a freewheel, and therefore the annulus 40 can rotate freely in a first direction of rotation and is held fixed against rotation in a second, opposite direction of rotation during the operation of the transmission assembly 1, and wherein a clutch 50 is provided between the drive shaft 12 and the planet carrier 30.

In the present case, the example shown is a schematic view of a segment of an electromechanical disk brake, although the transmission assembly 1 can also be used for or together with an electromechanical drum brake or else a multi-disk brake.

The assembly shown in the exemplary embodiment provides for a brake application force to be produced by means of an electric motor 2 or an electronic drive unit. For this purpose, the torque or drive torque produced by the electric motor 2 is initially transmitted to a single-stage spur gear mechanism with two gearwheels 5, 4 via a shaft 2.

The gearwheel 5 can be locked by means of a lock 6, likewise depicted only schematically, in order to implement the function of a parking brake.

From the shaft 4, the drive torque is transmitted onward to the drive shaft 12 of the planetary transmission 10, likewise by means of gearwheels.

The sun wheel 11 is connected for conjoint rotation to the drive shaft 12. The drive shaft 12 and the sun wheel 11 can, for example, be manufactured in one piece or can be assembled from individual components and connected to one another in an appropriate manner for conjoint rotation.

The planetary transmission 10 furthermore comprises a number of planet wheels 20, of which two are depicted in the exemplary embodiment and which are mounted rotatably on a planet carrier 30, also referred to as a spider. Finally, the planet wheels 20 are surrounded in a known manner by an annulus 40. The sun wheel 11, planet carrier 20 and annulus 40 can roll on one another. In the exemplary embodiment, they are in effective connection with one another via toothing.

The planet carrier 30 is in turn connected for conjoint rotation to the output shaft 32.

In this case, the planet carrier 30 and the output shaft 32 can, for example, be manufactured in one piece or can be assembled from individual components and connected to one another in an appropriate manner for conjoint rotation.

The output shaft 32 is in engagement with a ball screw drive 70. By means of a spindle nut 71, a braking element 80 can be moved in translation in the axial direction during operation. The braking element 80 can be part of an electromechanically actuated floating caliper brake and can, for example, comprise a pressure piston. The braking element 80 is designed with a rotation prevention means (not illustrated), which can engage in a corresponding undercut.

During the operation of the electromechanical wheel brake 100, a brake application force is applied, which acts on the braking element 80 in the direction denoted by “Z”. In operation, a corresponding braking torque can thereby be produced at the wheel under consideration. Before the braking element 80 comes into contact with the brake disk during operation, the release clearance first of all has to be traversed in the axial direction.

To traverse the release clearance, a relatively small torque must first of all be applied, and this then rises when the brake linings come into contact with the brake disk and, for example, are pressed against the brake disk in order to produce a braking torque.

The effect of the rise in the torque upon contact between the brake lining and the brake disk is used to shift the transmission assembly 1 from the at least first to the second reduction ratio.

Here, the first reduction ratio forms a rapid motion ratio in order to quickly traverse the release clearance when braking or at the beginning of a braking process during operation. The torque which must be applied during this process is lower than the torque which must be applied during active braking. In an embodiment, the magnitude of this torque can be, for example, 10% or 5% or less of the torque which is required during an active braking process.

Accordingly, the first reduction ratio is used at lower torques or in a first, low torque range, in which essentially the release clearance is to be traversed and active braking is not yet taking place, i.e. the brake linings are still essentially out of contact with the brake disk.

In the first torque range, as it were during the advance of the wheel brake, the torque is transmitted via the clutch 50 from the drive shaft 12 to the planet carrier 30 and thus to the output shaft 32 connected for conjoint rotation. For this purpose, the annulus 40 and the planet carrier 30 can rotate freely in the surrounding housing 90. The output of the planetary transmission 10 is driven directly by the drive with the aid of the clutch 50.

The clutch 50 is designed in such a way that it can transmit the drive torque to the output shaft 32 up to a predetermined torque. Accordingly, the torque limit of the clutch 50 is chosen in such a way that it corresponds approximately to the torque at which the advance of the brake lining makes a transition to pressing of the brake lining against the brake disk.

For this purpose, the freewheel 43 is oriented in such a way that, during a rotation in the brake application direction, a rotation of the annulus 40 can be brought about by the coupling of the sun wheel 11 to the planet carrier 30. Accordingly, the annulus 40 can freely co-rotate in one direction. Up to a predetermined torque, the planet carrier 30, the sun wheel 11 and the annulus 40 thus rotate at the same speed and in the same direction of rotation.

When, as the brake is applied further, the drive torque then becomes higher than the torque that can be transmitted via the clutch 50, the drive torque can no longer be transmitted via the clutch 50 since the torque is limited. This has the effect that the planet wheels 20 are driven by the sun wheel 11. Without locking, this would lead to further rotation of the annulus 40 in the opposite direction.

To prevent this, the freewheel 43 is provided, which hinders the reverse rotation movement of the annulus 40. In other words, by virtue of the freewheel 43, the annulus 40 remains held fixed against rotation when the torque limit is exceeded, and the planetary transmission 10 can operate with its second reduction ratio.

The second reduction ratio of the planetary transmission is thus used for the second torque range, in which a required torque for active braking must at least be made available in order to apply the required brake application force during the operation of the wheel brake 100.

Holding the annulus 40 fixed against rotation in the direction of reverse rotation has the effect that the torque of the drive shaft is transmitted to the planet wheels 20 via the sun wheel 11 and no longer via the clutch 50. Since the planet wheels 20 are also in effective interaction with the annulus 40, which is stationary in this direction, and roll on the latter, this leads to rotation of the planet carrier 30 and thus of the output shaft in accordance with the second reduction ratio.

Thus, an electromechanical wheel brake 100 or a transmission assembly 1 allows the release clearance to be traversed quickly and thus allows an improved response.

In the embodiment shown in FIG. 1, the clutch 50 is arranged between a side wall 35 of the planet carrier 30 and the end face 14 of the drive shaft 12.

The clutch 50 serves for direct transfer of the drive torque to the planet carrier 30 in the first torque range up to a predetermined torque. In this way, a reduction ratio of about 1:1 can be achieved in the direct drive mode of the transmission assembly 1.

In the case of a drive torque above the torque limit, the clutch 50 can no longer transmit the torque, and the second reduction ratio comes into use. In the second torque range, a second reduction ratio of, for example, 1:5 to 1:8 can then be achieved.

According to an embodiment, the clutch 50 is designed as an “overload clutch”. This makes it possible to ensure that as far as possible no driving energy is lost due to the clutch 50 in the second torque range, in which active braking takes place.

According to another embodiment, the clutch 50 can also comprise a friction clutch, as indicated in FIG. 1. The friction clutch can apply a predetermined static friction to the drive shaft 12 when it is firmly connected to the planet carrier 30 or to the planet carrier 30 when it is firmly connected to the drive shaft 12.

In a development of this embodiment, provision is made to combine the clutch with another freewheel (not illustrated) in such a way that the clutch is in engagement only during the advance of the brake, and not during release. Therefore, no additional torque has to be produced during release.

As shown in FIG. 1, an axial bearing 60 is furthermore provided, via which an axial force that occurs during operation and may act on the output shaft 32 in direction A can be absorbed and transmitted to the housing 90. For this purpose, the output shaft 32 can comprise a radial projection 33, for example.

In the exemplary embodiment, the axial bearing 60 is shown as a rolling bearing, but it can also be designed as a ball bearing, for example.

In the embodiment shown in FIG. 1, the transmission assembly 1 comprises a freewheel 43, which is indicated only schematically in FIG. 1. The freewheel 43 is arranged between the annulus 40 and the housing 90 or comprises parts of the annulus 40 and/or of the housing 90. Corresponding receptacles can be provided for reception and retention. FIG. 5 shows one example of a freewheel 43, which will be explored in greater depth below.

FIG. 2 shows, by means of a diagram, the characteristic of the axial force F as a function of time during an illustrative braking process of a transmission assembly in comparison with a transmission assembly from the prior art. It is clearly apparent that the axial force 201 rises earlier in a transmission assembly 1 than the axial force 202 in a transmission assembly from the prior art. In the exemplary embodiment shown, the axial force in the transmission assembly 1 rises continuously from about 0.04 s to a certain point and then ceases to rise. From this time, in the example at about 0.21 s, the annulus is held fixed against rotation, and the transmission assembly 1 acts with the second reduction ratio. The axial force 202 according to the prior art reaches this value only at about 0.25 s and thus later. This indicates that the transmission assembly 1 allows more rapid, more dynamic braking.

FIG. 3 shows, in a diagram, the characteristic of the brake piston speed as a function of time during an illustrative braking process of a transmission assembly in comparison with a transmission assembly from the prior art. The characteristic of the brake piston speed in a transmission assembly 1 is plotted with the reference sign 301, and the characteristic of the brake piston speed in an assembly from the prior art is plotted with the reference sign 302.

FIG. 4 shows, in a diagram, the change in the position of a braking element in the axial direction as a function of time during a braking process of a transmission assembly 1 in comparison with a transmission assembly from the prior art. The position in a transmission assembly 1 is plotted with the reference sign 401, and the position in an assembly from the prior art is plotted with the reference sign 402. Here too, it is found that, in the transmission assembly 1, the position of the braking element from which active braking takes place is reached after only about 0.21 s, whereas this position is reached only after about 0.25 s following the initiation of the braking process in a transmission assembly from the prior art.

Finally, FIG. 5 shows a schematic sectional view of the transmission assembly 1 from FIG. 1 along a section axis which is indicated by B-B in FIG. 1. For the sake of clarity, only selected essential elements of the transmission assembly 1 are depicted; the drive shaft 12 or the planet carrier 30 are absent, for example. In this example, the transmission assembly 1 comprises three planet wheels 20.

In this exemplary embodiment, the freewheel 43 is implemented by means of a pawl-type freewheel. For this purpose, recesses 44, each in the form of toothing, are arranged on the outer wall of the annulus 40. In this case, the toothing is designed with a steeper flank and a shallow flank in each case. Furthermore, a total of four pawls 45 is provided, which are correspondingly in engagement with the toothing. By way of the respective shallow flank, the tip of one pawl 45 can slide in a direction indicated by the reference sign R when the annulus 40 rotates, whereas it strikes the steeper flank in the case of rotation in the opposite direction. In this way, positive engagement is brought about in a direction of rotation of the annulus 40 opposite to R, and the rotary motion is stopped.

The number of four such pawls 45, wherein in each case two opposite pawls 45 can be in engagement and the two others can be arranged offset by half the length or arc length of the recess, thus allowing rapid engagement of pawls 45 even after a rotary motion which corresponds to half the arc length of a recess. Of course, other arrangements of the pawls 45 are also possible and conceivable. The use of wedging elements or wedging rollers in or with the freewheel 43 is also possible.

Furthermore, an electromechanical wheel brake 100, for example for a motor vehicle, comprises a transmission assembly 1 as described above. The electromechanical wheel brake 100 can be used as a service brake. Use as a parking brake is also possible.

In yet another further aspect, the embodiments also includes a method for operating an electromechanical wheel brake 100 of a motor vehicle, comprising a transmission assembly 1 as described above.

1. A transmission assembly for an electromechanical wheel brake for a motor vehicle comprising:
a planetary transmission having a sun wheel, which is connected for conjoint rotation to a drive shaft, a number of planet wheels, which are rotatably mounted on a planet carrier, and an annulus surrounding the planet wheels;
wherein the planet carrier is connected for conjoint rotation to an output shaft;
wherein the planet wheels are supported by the planet carrier in such a way that they can rotate on both the sun wheel and the annulus;
wherein the annulus is a freewheel or comprises a freewheel, and can rotate freely in a first direction of rotation and is held fixed against rotation in a second, opposite direction of rotation during the operation of the transmission assembly such that the transmission assembly has at least a first and a second reduction ratio; and
a clutch located between the drive shaft and the planet carrier.

2. The transmission assembly as claimed in claim 1, wherein, in the first reduction ratio, the torque can be transmitted from the drive shaft to the output shaft via the clutch.

3. The transmission assembly as claimed in claim 1, wherein the clutch is designed as a physically solid element and is arranged between the end face of the drive shaft and the inner wall of the planet carrier.

4. The transmission assembly as claimed in claim 1, wherein the clutch comprises a torque limit.

5. The transmission assembly as claimed in claim 1, wherein, in the second reduction ratio, the torque can be transmitted from the drive shaft to the planet wheels via the sun wheel.

6. The transmission assembly as claimed in claim 1, wherein the clutch is designed as an overload clutch or as a friction clutch.

7. The transmission assembly as claimed claim 1, wherein the first direction of rotation corresponds to the direction of rotation of the drive shaft during brake application.

8. The transmission assembly as claimed in claim 1, wherein the freewheel comprises four pawls, wherein in each case two opposite pawls can be in engagement at the same time and two further opposite pawls can be arranged offset by half the length of a recess.

9. The transmission assembly as claimed in claim 1, wherein the freewheel comprises wedging elements or wedging rollers.

10. An electromechanical wheel brake for a motor vehicle, comprising:
a transmission assembly with a planetary transmission having a sun wheel, which is connected for conjoint rotation to a drive shaft, a number of planet wheels, which are rotatably mounted on a planet carrier, and an annulus surrounding the planet wheels;
wherein the planet carrier is connected for conjoint rotation to an output shaft;
wherein the planet wheels are supported by the planet carrier in such a way that they can rotate on both the sun wheel and the annulus;
wherein the annulus is a freewheel or comprises a freewheel, and can rotate freely in a first direction of rotation and is held fixed against rotation in a second, opposite direction of rotation during the operation of the transmission assembly such that the transmission assembly has at least a first and a second reduction ratio; and
a clutch located between the drive shaft and the planet carrier.

11. The electromechanical wheel brake as claimed in claim 10, wherein the wheel brake is a service brake or a parking brake.

12. A method for operating an electromechanical wheel brake of a motor vehicle, comprising;
rotating a freewheel freely in a first direction of rotation; and
holding the freewheel fixed against rotation in a second, opposite direction of rotation during the operation of a transmission assembly such that the transmission assembly has at least a first and a second reduction ratio.
